(19) United States
(12) Patent Application Publication
(10) Pub. No.: US 2014/0268360 A1
(43) Pub. Date: Sep. 18, 2014

(54) HEAD-MOUNTED DISPLAY

(71) Applicant: VALVE CORPORATION, (US)

(72) Inventor: JERI JANET ELLSWORTH, KIRKLAND, WA (US)

(21) Appl. No.: 13/831,180

(22) Filed: Mar. 14, 2013

(51) Int. Cl. G02B 27/01; G02B 27/00

(52) U.S. Cl. CPC G02B 27/0172; G02B 27/0093
USPC 359/632

(57) ABSTRACT

Methods and systems are disclosed for using a head-mounted display that may consist of an image projector mounted to the head that projects one or more images onto a screen in front of one or both of the user's eyes. Moreover, head-mounted displays may also include electronics to track the position of the user's head. This tracking information can then be used as an input to change the display projected to the user—creating a Virtual Realty environment. Head tracking may be combined with transparent or semi-transparent display screens, to enable a user to see both a projected image and the physical world beyond the display screen. In certain embodiments, tracking information may be used to adjust the location of a projected image to compensate for the detected head movement.

### BACKGROUND OF THE DISCLOSURE

1. Field of the Disclosure

The disclosure relates generally to methods and systems of projecting one or more images onto a screen in a head-mounted display. According to certain embodiments, one or more sensors may be used to detect movement of a head of a wearer of a head-mounted display and a controller may be used to reorient one or more mirrors to control the projection of one or more images to compensate for the detected head movement.

2. General Background

Head-mounted electronic displays have existed for many years. For example, helmet mounted displays were first deployed by the U.S. Army in the Apache helicopter in 1984. These head-mounted displays have many advantages over fixed displays. For example, head mounted displays may be relatively small and compact but can display images that, if they were to be displayed on conventional fixed displays, would require extremely large screens.

One issue when designing such a system is that the user may shift his head faster than the head-mounted display can redraw the image. This is because it takes some discrete period of time for the head tracker and graphics software to decide what image to draw. This is called the combined latency. Many head-mounted-display-based systems have a combined latency over 100 milliseconds (ms). At a moderate head or object rotation rate of 50 degrees per second, 100 ms of latency causes 5 degrees of angular error. When a high angular error is introduced, the image or the display will not be correlated with the physical world seen by the user. It is even more of a problem when the user's head moves so fast that part of the frame correlates with one head position and the rest of the frame correlates with a different head position. Once the graphics processor used to draw the frames has started drawing the frame, it is generally committed to drawing the entire frame and cannot compensate for changes in the user's head orientation. In order to keep the image shown on the screen correlated with user's head, it is necessary to design a separate system to move the frame with very low latency.

There is a need in the art for a system that can quickly compensate for the user's head movement.

### BRIEF DESCRIPTION OF THE DRAWINGS

By way of example, reference will now be made to the accompanying drawings, which are not to scale.

FIG. 1 illustrates a head-mounted display and its relevant components according to certain embodiments.

FIG. 2 illustrates a head-mounted display and its relevant components according to certain embodiments.

FIG. 3 depicts a label projected above an image according to certain embodiments.

FIG. 4 depicts a head-mounted display for projecting one or more labels onto a screen in accordance with certain embodiments.

FIG. 5 depicts a head-mounted display for adjusting the focus point for projecting one or more labels onto a screen in accordance with certain embodiments.

FIG. 6 depicts a head-mounted display with a label projected on a screen offset from an image in accordance with certain embodiments.

FIG. 7 depicts a head-mounted display with a label projected on a screen proximate an image in accordance with certain embodiments.

FIG. 8 depicts a flow chart for determining and compensating for head movement and adjusting the focus point of a projected image on a screen in accordance with certain embodiments.

FIG. 9A illustrates an exemplary networked environment and its relevant components according to certain embodiments.

FIG. 9B is an exemplary block diagram of a computing device that may be used to implement certain embodiments.

### DETAILED DESCRIPTION

Those of ordinary skill in the art will realize that the following description of certain embodiments is illustrative only and not in any way limiting. Other embodiments will readily suggest themselves to such skilled persons, having the benefit of this disclosure. Reference will now be made in detail to specific implementations as illustrated in the accompanying drawings. The same reference numbers will be used throughout the drawings and the following description to refer to the same or like parts.

In general, a head-mounted display may consist of an image projector mounted to the head that projects one or more images onto a screen in front of one or both of the user's eyes. Both the screen and the projector may be mounted onto the user's head such that they are in a fixed position relative to the user's eyes. The screen may be positioned between the projector and the user's eye in a rear-projection format or the screen may be positioned in front of both the projector and the eye in a front-projection format. Images on the display may be drawn as a series of discrete frames that may be displayed sequentially at high rate of speed. The frames may be displayed so rapidly that the human eye cannot detect individual frames but rather sees the series of images as continuous motion. The frames themselves may be drawn a line at a time and may take several microseconds to complete.

Moreover, head-mounted displays may also include electronics to track the position of the user's head. This tracking information can then be used as an input to change the display projected to the user—creating a Virtual Realty environment.

Head tracking may be combined with transparent or semi-transparent display screens, to enable a user to see both a projected image and the physical world beyond the display screen. A transparent screen may be combined with head tracking to superimpose images on the user's view of the physical world. For example, when the user looks at a particular person, the display may project that person's name as a label over the person's head. The head tracking function may allow the label to remain in a constant position over the person's head even when the user moves his head up, down, or sideways. This may be referred to as Augmented Reality.

In certain embodiments, a mirror may be positioned between a projector and a screen in front of the user's eye such that the image created by the projector bounces off the mirror before appearing on the display. This mirror may be interposed between the projector and the screen in both rear-projection and front-projection formats.

In certain embodiments, the mirror may be coupled to a pivoting actuator or other mechanical device known to those of skill in the art that may change the orientation of the mirror. In certain embodiments, the orientation of the mirror may be changed to change the position of the image from the projector relative to a fixed location on the screen. For example, the mirror can be moved to shift the entire frame shown by the projector up and down and/or left and right on the screen.

In certain embodiments, a controller may be used to move the mirror based on input from sensors measuring the movement of the user's head. Thus, the mirror may be used to keep the image shown on the screen in a fixed position even when the user moves his head.

In certain embodiments, the mirror may be positioned at a fixed “centered” position at the start of each frame. While the frame is drawn, the mirror may act to move the entire image to keep it in the desired position. At the end of the frame, the mirror may then be re-centered. In certain embodiments, the software controlling the projector may not need to compensate for head movement during the drawing of the frame, but rather at the start of each frame.

In certain embodiments, a head-mounted display is disclosed, comprising: a screen; a projector for projecting one or more images onto one or more mirrors; a controller for orienting the one or more mirrors to direct the one or more images onto one or more locations on the screen. The head-mounted display may further comprise: one or more sensors for detecting movement of a head of a wearer of the head-mounted display; and wherein the controller is configured for orienting the one or more mirrors to redirect the one or more images to compensate for the detected head movement. The projector may be configured for rendering the one or more images in one or more frames. The controller may be configured to center the one or more mirrors between each of the one or more frames. The projector may be configured for projecting images on the back of the screen. The projector may be configured for projecting images on the front of the screen. The one or more images may comprise one or more labels and the one or more locations may comprise one or more locations on the screen proximate to one or more objects viewable through the screen. The screen may be transparent. The screen may be semi-transparent. The controller may comprise a rotating actuator. The controller may comprise one or more actuators for orienting the one or more mirrors in one or more dimensions.

In certain embodiments, a method for compensating for head movement of a wearer of a head-mounted display is disclosed, comprising: providing a head-mounted display comprising a screen: projecting one or more images onto one or more mirrors; orienting the one or more mirrors to redirect the one or more images onto one or more locations on the screen. The method may further comprise: detecting movement of a head of a wearer of the head-mounted display; and orienting the one or more mirrors to redirect the one or more images to compensate for the detected head movement. The step of projecting one or more images may comprise projecting one or more frames. The step of orienting the one or more mirrors may comprise centering the one or more mirrors between each of the one or more frames. The one or more images may comprise one or more labels and the one or more locations may comprise one or more locations on the screen proximate one or more objects viewable through the screen. The screen may be transparent. The screen may be semi-transparent.

Further, certain figures in this specification are flow charts illustrating methods and systems. It will be understood that each block of these flow charts, and combinations of blocks in these flow charts, may be implemented by computer program instructions. These computer program instructions may be loaded onto a computer or other programmable apparatus to produce a machine, such that the instructions which execute on the computer or other programmable apparatus create structures for implementing the functions specified in the flow chart block or blocks. These computer program instructions may also be stored in a computer-readable memory that may direct a computer or other programmable apparatus to function in a particular manner, such that the instructions stored in the computer-readable memory produce an article of manufacture including instruction structures which implement the function or functions specified in the flow chart block or blocks. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flow chart block or blocks.

Accordingly, blocks of the flow charts support combinations of structures for performing the specified functions and combinations of steps for performing the specified functions. It will also be understood that each block of the flow charts, and combinations of blocks in the flow charts, can be implemented by special purpose hardware-based computer systems which perform the specified functions or steps, or combinations of special purpose hardware and computer instructions.

For example, any number of computer programming languages, such as C, C++, C# (CSharp), Perl, Ada, Python, Pascal, SmallTalk, FORTRAN, assembly language, and the like, may be used to implement aspects of the present invention. Further, various programming approaches such as procedural, object-oriented or artificial intelligence techniques may be employed, depending on the requirements of each particular implementation. Compiler programs and/or virtual machine programs executed by computer systems may translate higher level programming languages to generate sets of machine instructions that may be executed by one or more processors to perform a programmed function or set of functions.

The term “machine-readable medium” may include any structure that participates in providing data which may be read by an element of a computer system. Such a medium may take many forms, including but not limited to, non-volatile media, volatile media, and transmission media. Non-volatile media may include, for example and without limitation, optical or magnetic disks and other persistent memory. Volatile media may include, for example and without limitation, dynamic random access memory (DRAM) and/or static random access memory (SRAM). Transmission media may include, for example and without limitation, cables, wires, and fibers, including the wires that comprise a system bus coupled to processor. Common forms of machine-readable media include, for example and without limitation, a floppy disk, a flexible disk, a hard disk, a magnetic tape, any other magnetic medium, a CD-ROM, a DVD, any other optical medium.

In certain embodiments, as shown in FIG. 1, a mirror 103 may be included in a front-projection configuration. A screen 104 may be positioned in front of the eye 101. A projector 102 may be positioned behind the user's eye. The images created by the projector 102 may be reflected off of a mirror 103 before being projected onto the front of screen 104.

In certain embodiments, as shown in FIG. 2, a mirror 203 may be included in a rear-projection configuration. A screen 204 may be positioned in front of the eye 201. A projector 202 may also be positioned in front of the user's eye. The images created by the projector 202 may be reflected off of a mirror 203 before being projected onto the rear of screen 204.

For the sake of simplicity, FIGS. 1 and 2 include only one screen in front of one eye. One of ordinary skill in the art will understand that a variety of configurations may be used without departing from the scope of the present invention as defined by the claims hereto. For example and without limitation, one screen may be placed in front of each eye, a large screen may be placed in front of both eyes, a screen may be placed in front of only one of the eyes, or a plurality of screens may be placed in front of one or both eyes. In FIG. 1, the screen 104, the projector 102, and the mirror 103 may be fixed in position relative to the eye 101, for example and without limitation by mounting the components on a pair of eyeglasses or a helmet that is worn by the user. Similarly in FIG. 2, the screen 204, the projector 202, and the mirror 203 may be fixed in position relative to the eye 201, for example and without limitation by mounting the components on a pair of eyeglasses or a helmet that is worn by the user.

The screens 104 and 204 may be transparent or semitransparent such that the user may see images on the screens 104 and 204 and objects in the real world substantially simultaneously. For example and without limitation, in FIG. 3, a label 352 may be projected above an object 351 in front of a user. In certain embodiments as shown in FIG. 4, object 451 may exist behind the screen 404. The projector 402 may project an image of label 452 off of mirror 403 and onto screen 404. From the perspective of the eye 401, the label 452 appears above the object 451, even though the object 451 may be “real” and the label 452 may be “virtual.” In certain embodiments, FIG. 4 depicts a front projection configuration similar to FIG. 1, but one of ordinary skill in the art will understand that the same principles may be used with the rear projection setup described in FIG. 2.

In certain embodiments as shown in FIG. 5, a pivoting actuator 505 may be used to control the orientation of mirror 503. As in FIG. 1, a screen 504 may be positioned in front of the eye 501 and a projector 502 is positioned behind the user's eye. The images created by the projector 502 are reflected off of a mirror 503 before being projected onto the front of screen 504. In certain embodiments, the angle of the mirror 503 may be controlled by the pivoting actuator 505 and thereby control the position of the image on the screen 504. For example and without limitation, pivoting actuator 505 may be used to rotate the mirror 503 clockwise, would shift the image projected by the projector 502 toward the right hand side of the screen 504. While FIG. 5 is shown in two dimensions, one of ordinary skill in the art will understand that mirror 503 may be rotated by pivoting actuator 505 in three dimensions to move the image up, down, left and right relative to screen 504. One of ordinary skill in the art also will understand that the pivoting actuator 505 may alternately be used to control a mirror in the rear projection setup shown in FIG. 2.

In certain embodiments as shown in FIG. 6, a user may rotate his head clockwise by 15 degrees causing misalignment between the label 652 and an object 651. In this situation, the angle and positions of the eye 601, projector 602, mirror 603, and screen 604 have changed but the object 651 remains stationary. Because of changed position of the projector 602, mirror 603, and screen 604, from the point of view of the eye 601, the position of the label 652 has changed relative to the object 651 such that they are no longer in alignment.

In certain embodiments as shown in FIG. 7, a tracker 706 may be used to correct for the misalignment introduced in FIG. 6. The tracker 706 may detect the rotation of a user's head. The methods of detecting head motion are well-known in the art and can include without limitation optical detection, gyroscopes, and/or accelerometers. Input from the tracker 706 may be used to control the pivoting actuator 705. For example and without limitation, tracker 706 may instruct pivoting actuator 705 to rotate the mirror clockwise. This rotation of the mirror 703 may shift the position of the label 752 relative to the object 751 such that the label 752 projected by projector 702 onto screen 703 remains in alignment relative to the object 651 when seen from the eye 701. The input from the tracker 706 may be used to control the pivoting actuator 705 in a continuous feedback loop to keep the label 752 in alignment with the object 751 regardless of how the user's head moves.

In certain embodiments as shown in FIG. 8, pivoting actuator 705 may be controlled using feedback from the tracker 706 combined with frame-drawing software 807 to minimize cumulative displacement of the mirror 703 by recentering the mirror at the end of each frame. In response to movement of the head 871, in step 872, the tracker 706 may measure the movement of the head using any of the methods of tracking described above or known to those of ordinary skill in the art. Next, in step 873, the tracker may calculate how much to move the mirror in order to keep a label 752 in alignment with an object 751. Next, in step 874, the tracker may cause the pivoting actuator 705 to move the mirror 703 to keep the label 752 in alignment with an object 851. Up to this point, the system may be operating very similarly to the system shown in FIG. 7. In step 874, frame-drawing software may determine whether the frame currently being drawn has finished. If the frame is not yet fully drawn, the sequence may be repeated starting from step 872. However, if the frame is finished, the frame-drawing software 807 may instruct the pivoting actuator 705 to move the mirror back into a “centered” alignment. The frame-drawing software 807 may then start drawing the next frame such that the label 752 is correctly aligned with the object 751.

Certain figures in this specification are flow charts illustrating methods and systems. It will be understood that each block of these flow charts, and combinations of blocks in these flow charts, may be implemented by computer program instructions. These computer program instructions may be loaded onto a computer or other programmable apparatus to produce a machine, such that the instructions which execute on the computer or other programmable apparatus create structures for implementing the functions specified in the flow chart block or blocks. These computer program instructions may also be stored in a computer-readable memory that can direct a computer or other programmable apparatus to function in a particular manner, such that the instructions stored in the computer-readable memory produce an article of manufacture including instruction structures which implement the function specified in the flow chart block or blocks. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flow chart block or blocks.

Accordingly, blocks of the flow charts support combinations of structures for performing the specified functions and combinations of steps for performing the specified functions. It will also be understood that each block of the flow charts, and combinations of blocks in the flow charts, can be implemented by special purpose hardware-based computer systems which perform the specified functions or steps, or combinations of special purpose hardware and computer instructions.

For example, any number of computer programming languages, such as C, C++, C# (CSharp), Perl, Ada, Python, Pascal, SmallTalk, FORTRAN, assembly language, and the like, may be used to implement certain embodiments. Further, various programming approaches such as procedural, object-oriented or artificial intelligence techniques may be employed, depending on the requirements of each particular implementation. Compiler programs and/or virtual machine programs executed by computer systems may translate higher level programming languages to generate sets of machine instructions that may be executed by one or more processors to perform a programmed function or set of functions.

The term “machine-readable medium” should be understood to include any structure that participates in providing data which may be read by an element of a computer system. Such a medium may take many forms, including but not limited to, non-volatile media, volatile media, and transmission media. Non-volatile media include, for example, optical or magnetic disks and other persistent memory. Volatile media include dynamic random access memory (DRAM) and/or static random access memory (SRAM). Transmission media include cables, wires, and fibers, including the wires that comprise a system bus coupled to processor. Common forms of machine-readable media include, for example, a floppy disk, a flexible disk, a hard disk, a magnetic tape, any other magnetic medium, a CD-ROM, a DVD, any other optical medium.

FIG. 9A depicts an exemplary networked environment 905 in which systems and methods, consistent with exemplary embodiments, may be implemented. As illustrated, networked environment 905 may include a server 915, a client/receiver 925, and a network 935. The exemplary simplified number of servers 915, clients/receivers 925, and networks 935 illustrated in FIG. 9A can be modified as appropriate in a particular implementation. In practice, there may be additional servers 915, clients/receivers 925, and/or networks 935.

Network 935 may include one or more networks of any type, including a Public Land Mobile Network (PLMN), a telephone network (e.g., a Public Switched Telephone Network (PSTN) and/or a wireless network), a local area network (LAN), a metropolitan area network (MAN), a wide area network (WAN), an Internet Protocol Multimedia Subsystem (IMS) network, a private network, the Internet, an intranet, and/or another type of suitable network, depending on the requirements of each particular implementation.

One or more components of networked environment 905 may perform one or more of the tasks described as being performed by one or more other components of networked environment 905.

FIG. 9B is an exemplary diagram of a computing device 1000 that may be used to implement certain embodiments, such as aspects of server 915 or of client/receiver 925. Computing device 1000 may include a bus 1001, one or more processors 1005, a main memory 1010, a read-only memory (ROM) 1015, a storage device 1020, one or more input devices 1025, one or more output devices 1030, and a communication interface 1035. Bus 1001 may include one or more conductors that permit communication among the components of computing device 1000.

Processor 1005 may include any type of conventional processor, microprocessor, or processing logic that interprets and executes instructions. Main memory 1010 may include a random-access memory (RAM) or another type of dynamic storage device that stores information and instructions for execution by processor 1005. ROM 1015 may include a conventional ROM device or another type of static storage device that stores static information and instructions for use by processor 1005. Storage device 1020 may include a magnetic and/or optical recording medium and its corresponding drive.

Input device(s) 1025 may include one or more conventional mechanisms that permit a user to input information to computing device 1000, such as a keyboard, a mouse, a pen, a stylus, handwriting recognition, voice recognition, biometric mechanisms, and the like. Output device(s) 1030 may include one or more conventional mechanisms that output information to the user, including a display, a projector, an A/V receiver, a printer, a speaker, and the like. Communication interface 1035 may include any transceiver-like mechanism that enables computing device/server 1000 to communicate with other devices and/or systems. For example, communication interface 1035 may include mechanisms for communicating with another device or system via a network, such as network 1035 as shown in FIG. 9A.

As will be described in detail below, computing device 1000 may perform operations based on software instructions that may be read into memory 1010 from another computer-readable medium, such as data storage device 1020, or from another device via communication interface 1035. The software instructions contained in memory 1010 cause processor 1005 to perform processes that will be described later. Alternatively, hardwired circuitry may be used in place of or in combination with software instructions to implement processes consistent with the present invention. Thus, various implementations are not limited to any specific combination of hardware circuitry and software.

Certain embodiments of the present invention described herein are discussed in the context of the global data communication network commonly referred to as the Internet. Those skilled in the art will realize that embodiments of the present invention may use any other suitable data communication network, including without limitation direct point-to-point data communication systems, dial-up networks, personal or corporate Intranets, proprietary networks, or combinations of any of these with or without connections to the Internet.

While the above description contains many specifics and certain exemplary embodiments have been described and shown in the accompanying drawings, it is to be understood that such embodiments are merely illustrative of and not restrictive on the broad invention, and that this invention is not limited to the specific constructions and arrangements shown and described, since various other modifications may occur to those ordinarily skilled in the art, as mentioned above. The invention includes any combination or subcombination of the elements from the different species and/or embodiments disclosed herein.

We claim:

1. A head-mounted display, comprising:
a screen;
a projector for projecting one or more images onto one or more mirrors;
a controller for orienting the one or more mirrors to direct the one or more images onto one or more locations on the screen.

2. The head-mounted display of claim 1, further comprising:
one or more sensors for detecting movement of a head of a wearer of the head-mounted display; and
wherein the controller is configured for orienting the one or more mirrors to redirect the one or more images to compensate for the detected head movement.

3. The head-mounted display of claim 1, wherein the projector is configured for rendering the one or more images in one or more frames.

4. The head-mounted display of claim 3, wherein the controller is configured to center the one or more mirrors between each of the one or more frames.

5. The head-mounted display of claim 1, wherein the projector is configured for projecting images on the back of the screen.

6. The head-mounted display of claim 1, wherein the projector is configured for projecting images on the front of the screen.

7. The head-mounted display of claim 1, wherein the one or more images comprise one or more labels and the one or more locations comprise one or more locations on the screen proximate to one or more objects viewable through the screen.

8. The head-mounted display of claim 1, wherein the screen is transparent.

9. The head-mounted display of claim 1, wherein the screen is semi-transparent.

10. The head-mounted display of claim 1, wherein the controller comprises a rotating actuator.

11. The head-mounted display of claim 1, wherein the controller comprises one or more actuators for orienting the one or more mirrors in one or more dimensions.

12. A method for compensating for head movement of a wearer of a head-mounted display, comprising:
providing a head-mounted display comprising a screen:
projecting one or more images onto one or more mirrors;
orienting the one or more mirrors to redirect the one or more images onto one or more locations on the screen.

13. The method of claim 12, further comprising:
detecting movement of a head of a wearer of the head-mounted display; and
orienting the one or more mirrors to redirect the one or more images to compensate for the detected head movement.

14. The method of claim 12, wherein the step of projecting one or more images comprises projecting one or more frames.

15. The method of claim 14, wherein the step of orienting the one or more mirrors comprises centering the one or more mirrors between each of the one or more frames.

16. The method of claim 12, wherein the one or more images comprise one or more labels and the one or more locations comprises one or more locations on the screen proximate one or more objects viewable through the screen.

17. The method of claim 12, wherein the screen is transparent.

18. The method of claim 12, wherein the screen is semi-transparent.
